(19) United States
(12) Patent Application Publication
(10) Pub. No.: US 2022/0067638 A1
(43) Pub. Date: Mar. 3, 2022

(54) SYSTEMS AND METHODS OF PROCESSING METADATA FOR PRODUCT REGISTRATION

(71) Applicant: Coupang Corp., Seoul (KR)

(72) Inventors: Hao Wu, Bellevue, WA (US); Xin Shi, Bellevue, WA (US); Weiquan Li, Bothell, WA (US); Xuelei Sun, Bellevue, WA (US); Junseo Hong, Gyeonggi-do (KR)

(73) Assignee: Coupang Corp., Seoul (KR)

(21) Appl. No.: 17/006,376

(22) Filed: Aug. 28, 2020

(51) Int. Cl. G06Q 10/08; G06Q 10/10; G06Q 30/00; G06F 16/21; G06F 16/22; G06N 5/04

(52) U.S. Cl. CPC G06Q 10/087; G06Q 10/10; G06Q 30/0185; G06F 9/54; G06F 16/22; G06N 5/04; G06F 16/212

(57) ABSTRACT

Disclosed herein are systems and methods for product registration and validation in a retail environment. The system may comprise a memory storing instructions and one or more processors configured to execute instructions to perform operations. These operations may comprise receiving a request from a user device for a product registration template for a product category; retrieving metadata relating to the product category from a first database; generating a product registration template from the metadata; sending the product registration template to the user device; receiving product properties for the one or more products through the user device utilizing the product registration template; validating the received product properties against a predefined schema; storing the validated product properties in a second database; and registering the one or more products on the web server.

### TECHNICAL FIELD

The present disclosure generally relates to systems and methods for aggregating and managing data for product onboarding in a multi-user environment. More particularly, embodiments of the present disclosure relate to inventive and unconventional systems for product registration and validation in a retail environment.

### BACKGROUND

Product registration and onboarding processing in e-commerce includes receiving product data from various manufacturers and suppliers that must be unified to fit a retailer's catalog or commerce system. For example, in e-commerce, retailers need product data from vendors to categorize products in order to facilitate product procurement, sales, inventory, transportation, delivery, and other aspects of business processes. In many situations, the retailers must deal with an array of requirements for different data formats. In some cases, the product data format of the collected data may be dictated by the manufacturers or suppliers, which may slow down the product onboarding process.

Some existing solutions for product registration and analysis from multiple vendors are not adaptable to different formats of product data. Retailers who receive product data that is not in a preferred format need to translate and validate the incoming data. More particularly, retailers need to translate supplier formats into retailer formats. However, those existing solutions lack such capability, which may slow down the onboarding process. Throughout the various stages of product registration and analysis there are various requests pushed and received across a network that results in utilization of numerous network resources. As these requests are pushed and received there are network delays between the responses that affect the network performance and thus negatively impact user experience. Furthermore, those solutions may not be able to validate product data.

Therefore, there is a need for an onboarding process that can assure fast product onboarding while maintaining data consistency.

### SUMMARY

One aspect of the present disclosure is directed to a system for registering one or more products on a web server, the system comprising: a memory storing instructions; and one or more processors configured to execute the instructions to perform steps comprising receiving a request from a user device for a product registration template for a product category; retrieving metadata relating to the product category from a first database; generating a product registration template from the metadata; sending the product registration template to the user device; receiving product properties for the one or more products through the user device utilizing the product registration template; validating the received product properties against a predefined schema; storing the validated product properties in a second database; and registering the one or more products on the web server.

Another aspect of the present disclosure is directed to a computer-implemented method for registering one or more products on a web server, the method comprising: receiving a request from a user device for a product registration template for a product category; retrieving metadata relating to the product category from a first database; generating a product registration template from the metadata; sending the product registration template to the user device; receiving product properties for the one or more products through the user device utilizing the product registration template; validating the received product properties against a predefined schema; storing the validated product properties in a second database; and registering the one or more products on the web server.

Yet another aspect of the present disclosure is directed to a system for registering one or more products on a web server, the system comprising: a memory storing instructions; and one or more processors configured to execute the instructions to perform steps comprising: receiving metadata for a product category through an administrator user interface; generating a schema based on the received metadata; storing the schema in a first database; receiving a request from a user device for a product registration template for the product category; retrieving the schema relating to the product category from the first database; generating a product registration template from the schema; sending the product registration template to the user device; receiving product properties for the one or more products through the user device utilizing the product registration template; validating the received product properties by determining whether the product properties match a structure set by the schema; storing the validated product properties in a second database; and registering the one or more products on the web server.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a block diagram illustrating an exemplary system for product registration, consistent with the disclosed embodiments.

FIG. 4 is an illustration of a product registration server, consistent with the disclosed embodiments.

FIG. 5 depicts a JSON Schema with metadata for product category “clothing”, consistent with the disclosed embodiments.

FIG. 6 is a flow chart illustrating an exemplary method for managing metadata, consistent with the disclosed embodiments.

FIG. 7 is a flow chart illustrating an exemplary method of product registration, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured to aggregate and manage data for product onboarding in a multi-user environment. The disclosed embodiments provide innovative technical features that enable registering one or more products relating to a product category by automatically generating a product registration template and validating the input product data. For example, the disclosed embodiments receive a product category and a request for a product registration template; generate a product registration template based on the metadata for the product category; receive product data; and validate the product data against a schema.

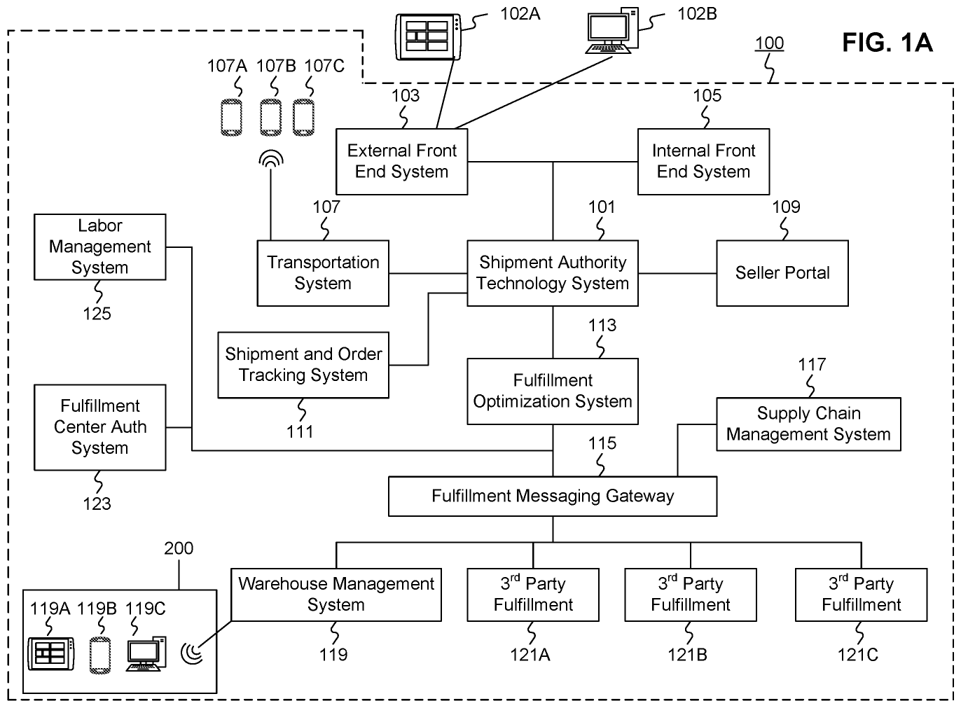

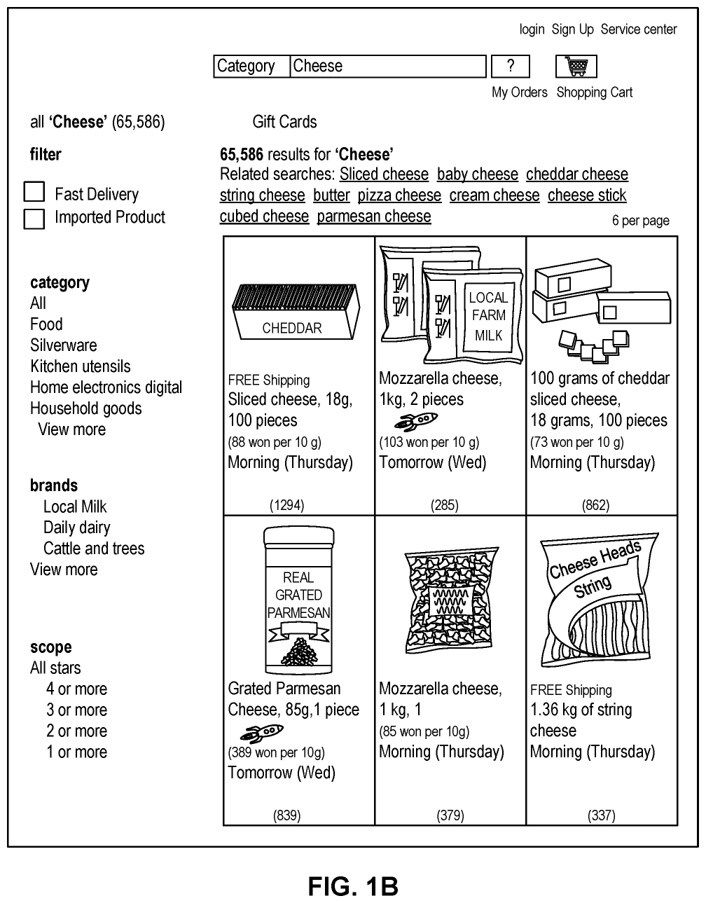

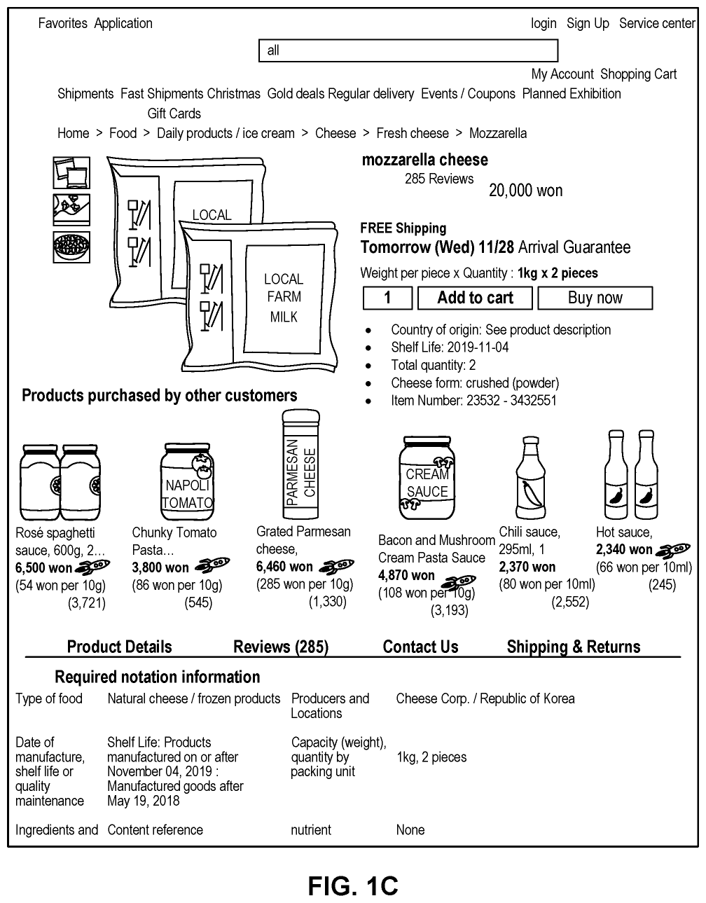

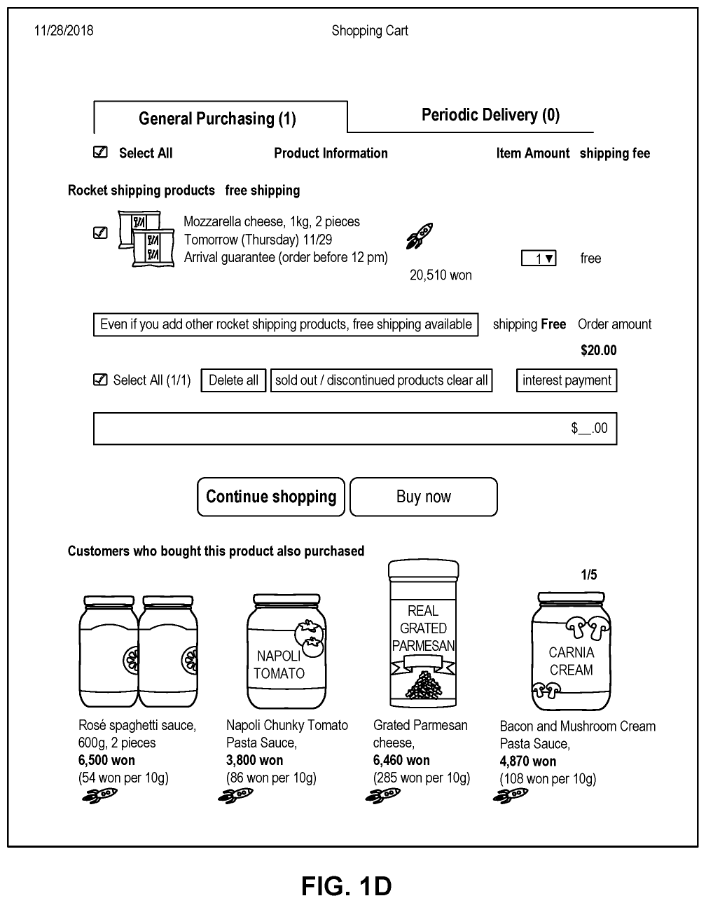

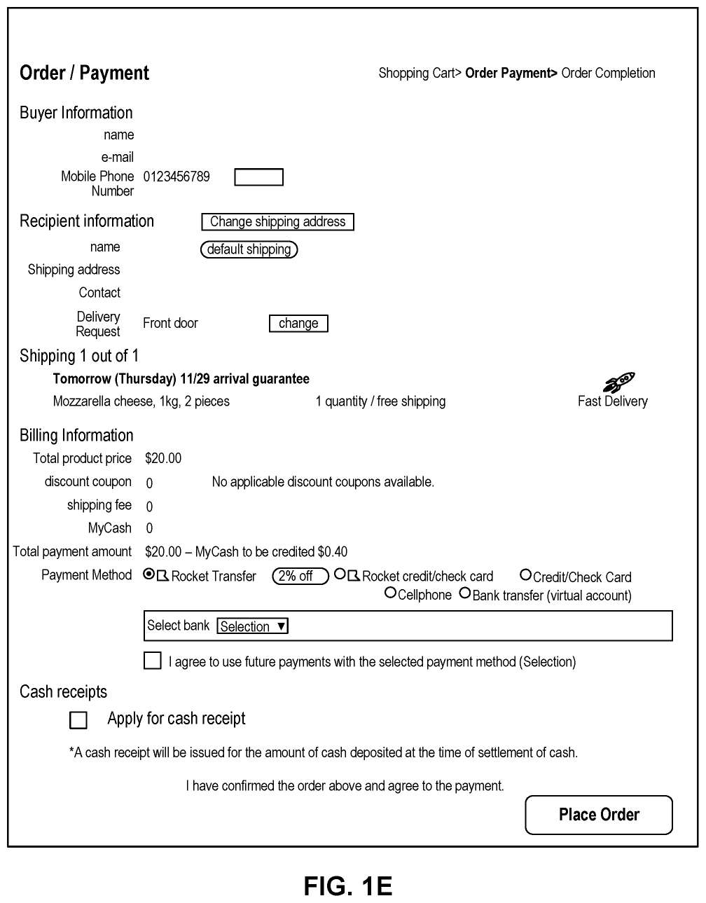

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3rd party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3rd party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

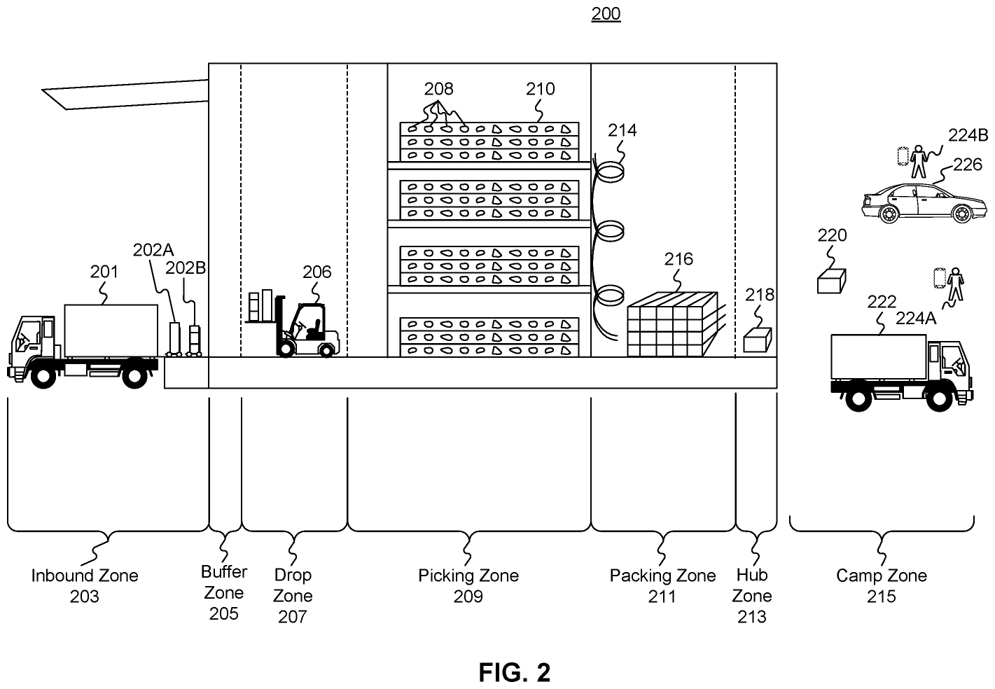

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3rd party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

Embodiments of the present disclosure are directed to systems, apparatuses, and methods configured for collecting product data from different vendors, validating product data based on validation conditions, registering products based on the product data and generating templates for streamlining future product registration processes. Using the systems and methods disclosed in the present embodiments the vendors can upload product data in any format of their choice, for example, an Excel-file, a web-interface, a mobile application, etc., which is then converted to a predefined format and validated against predefined schema which affectively shortens the product registration cycle.

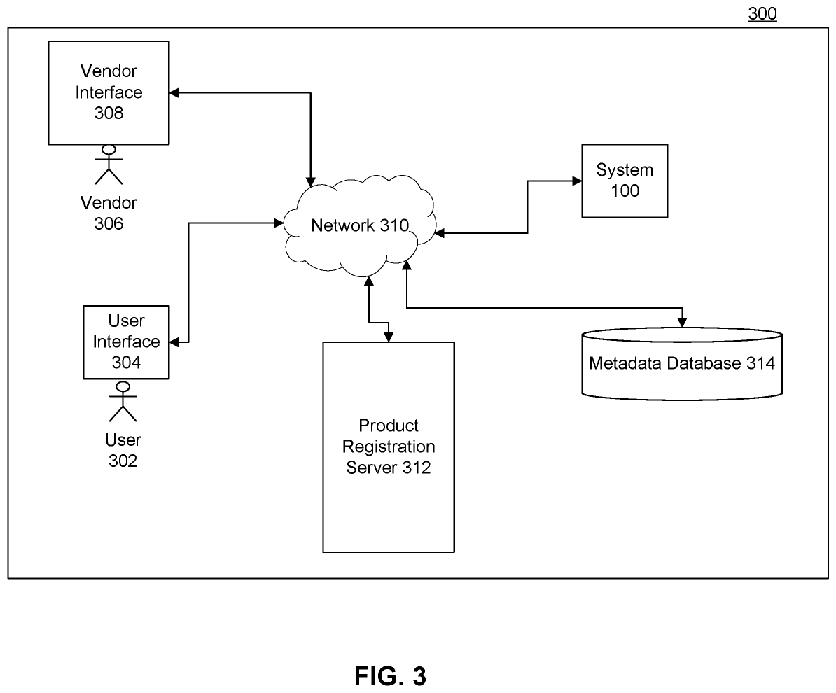

FIG. 3 is a block diagram illustrating an exemplary system for product registration. As illustrated in FIG. 3, 300 may include a variety of systems, each of which may be connected to one another via one or more wireless networks. The systems may also be connected to one another via a direct connection, for example, using a cable. In some embodiments, 300 may be associated with a software developer, company, and/or other entity involved with creating user interfaces or other data for user applications or devices. In some embodiments, 300 may include multiple computing devices communicably connected to each other within a local network (e.g., through a network interface). The depicted systems include system 100, a user interface 304, a vendor interface 308, a network 310, a product registration server 312, and a metadata database 314. Herein, metadata may be described as the “data about data,” that is, the data that provides information about other data. For example, metadata may comprise fields defining different product properties (e.g., ID, stock keeping unit (SKU), name, price, etc.), keys defining a first part of a validation rule (e.g., type, required, array, etc.), and values defining a second part of a validation rule (e.g., for “type”: string, integer, object, etc.).

User interface 304, in some embodiments, may be implemented as an interface that enables a retailer administrator, e.g., a user 302, to interact with one or more systems in 300. For example, in embodiments where 300 enables metadata to be managed, user interface 304 may be used by user 302 to visualize the metadata and make changes to it. In one such embodiment, user interface 304 receives a request from user 302 to view the metadata for a specific product category (product categories are discussed further below with respect to vendor interface 308). User interface 304 then sends the user request through network 310 to product registration server 312, which then pulls the requested metadata from metadata database 314 and returns it to user interface 304, where it can be viewed by user 302. User 302 can then make changes to the metadata, the user changes being sent to product registration server 312 via network 310, which in turn modifies the metadata in metadata database 314 to incorporate the changes.

Vendor interface 308, in some embodiments, may be implemented as a platform that enables a vendor 306 to interact with one or more systems in 300. For example, in embodiments where 300 enables vendor 306 to input product data, vendor interface 308 may be implemented as a web server that receives requests for product registration templates and allows vendor 306 to input product data utilizing the product registration templates. The product data may include, for example, product categories (e.g., clothes, groceries, electronics, etc.), vendor country (i.e., where vendor 306 is located), and product properties (e.g., product name, stock keeping unit (SKU), vendor item, etc.). For example, vendor 306, who wishes to input product data, will first input the product category into vendor interface 308. Vendor interface 308 will then send the product category to product registration server 312, which will then match the product category to corresponding metadata in metadata database 314. Product registration server 312 then uses the corresponding metadata to generate a product registration template, which it then sends to vendor interface 308. Vendor 306 may now input the rest of the product data through vendor interface 308 utilizing the product registration template. Finally, the product data input utilizing the product registration template are sent to product registration server 312 for validation, and upon acceptance, is stored in one or more of the devices represented in system 100.

Product registration server 312, in some embodiments, may be a web server. Product registration server 312, for example, may include hardware (e.g., one or more computers, including processors, storage, and input/output devices) and/or software (e.g., one or more applications) that deliver web content that can be accessed by, for example, a user (e.g., user 302 or vendor 306) through a network (e.g., network 310), such as the Internet. Product registration server 312 may use, for example, a hypertext transfer protocol (HTTP or sHTTP) to communicate with the user. The web pages delivered to the user may include, for example, HTML documents, which may include images, style sheets, and scripts in addition to text content.

A user program such as, for example, a web browser, web crawler, or native mobile application (e.g., user interface 304 or vendor platform 308), may initiate communication by making a request for a specific resource using HTTP and product registration server 312 may respond with the content of that resource or an error message if unable to do so. Product registration server 312 also may enable or facilitate receiving content from the user so the user may be able to, for example, submit web forms, including the uploading of files. Product registration server 312 may also support server-side scripting using, for example, Active Server Pages (ASP), PHP, or other scripting languages. Accordingly, the behavior of product registration server 312 can be scripted in separate files, while the actual server software remains unchanged.

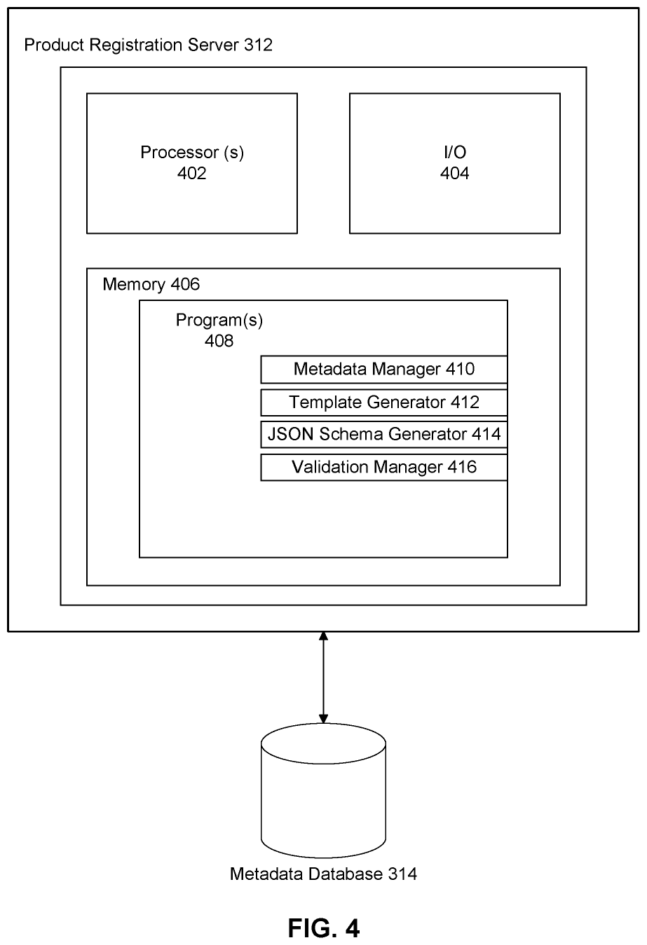

In other embodiments, product registration server 312 may be an application server, which may include hardware and/or software that is dedicated to the execution of procedures (e.g., programs routines, scripts) for supporting its applied applications. Product registration server 312 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Product registration server 312 may act as a set of components accessible to, for example, an entity implementing system 100, through an API defined by the platform itself. Product registration server 312 is further discussed below with respect to FIG. 4.

Metadata database 314, in some embodiments, may be used to store metadata regarding product registration. Metadata database 314 may include one or more memory devices that store information and are accessed and/or managed by one or more components of 300. By way of example, metadata database 314 may include Oracle™ databases, Sybase™ databases, or other relational databases or nonrelational databases, such as Hadoop sequence files, HBase, or Cassandra. Metadata database 314 may include computing components (e.g., database management system, database server, etc.) configured to receive and process requests for data stored in memory devices of metadata database 314 and to provide data from metadata database 314. In another embodiment, product registration server 312 may store metadata database 314 locally within it. By way of example, metadata database 314 may be stored in memory 406. In some embodiments, metadata database 314 includes at least fields for storing product categories and corresponding product metadata.

FIG. 4 is an illustration of an exemplary implementation of product registration server 312. As shown in FIG. 4, product registration server 312 may include a variety of components, including one or more processors (e.g., processor 402), input and output devices (e.g., I/O 404), and a memory (e.g., memory 406). Memory 406 may be configured to store a plurality of programs (e.g., programs 408), for execution by processor 402, such programs including a metadata manager 410, a template generator 412, a JSON Schema generator 414, and a validation manager 416.

Processor 402 may include one or more known processing devices, such as a microprocessor from the Pentium™ or Xeon™ family manufactured by Intel™, or the Turion™ family manufactured by AMO™, for example. The disclosed embodiments are not limited to any type of processor(s) otherwise configured to meet the computing demands required of different components of 300. Processor 402 may execute metadata manager 410, in some embodiments, to retrieve metadata relating to a product category input by vendor 306 from metadata database 314. In other embodiments, processor 402 may execute metadata manager 410 to modify metadata database 314 if directed to do so by user 302. Modifying metadata database 314 is further discussed below with respect to JSON Schema generator 414.

Processor 402 may execute template generator 412, in some embodiments, to utilize metadata retrieved from metadata database 314 to generate a product registration template that will be used by vendor 306 to input the product properties for one or more products to be registered. For example, vendor 306 may request to input product data for a product category through vendor interface 308. Processor 402 receives this request and executes metadata manager 410 to retrieve the metadata found in metadata database 314 for this product category. Processor 402 then executes template generator 412 to generate a product registration template by extracting appropriate fields from the metadata and creating a form where vendor 306 may input product data. Processor 402 then sends the product registration template to vendor interface 308. Vendor 306 may then use the product registration template to input the rest of the product data.

Processor 402 may execute JSON Schema generator 414, in some embodiments, to modify the JSON Schema saved in metadata database 314 for a product category. For example, user 302 may send a request to modify the metadata of a product category through user interface 304. Processor 402 receives this request and executes metadata manager 410 to return a copy of the metadata found in metadata database 314 for this product category to user interface 304. User interface 304 then displays a simplified version of the metadata (i.e., not JSON Schema) so that user 302 may easily make modifications to the metadata. After user 302 makes any modifications, the modifications are logged by user interface 304 and sent to processor 402, which then executes JSON Schema generator 414 to write a new JSON Schema for that product category. Writing the new JSON Schema includes creating a blank .json or .schema.json file, extracting relevant fields, keys, and values from the received modified metadata, and writing, in JSON, a schema utilizing the extracted fields, keys, and values. Processor 402 then saves the new JSON Schema in metadata database 314 under the same product category by executing metadata manager 410, overwriting any previous version of the JSON Schema for that product category. In other embodiments, processor 402 may execute JSON Schema generator 414 to generate a JSON Schema that supports complex validations involving multiple fields. Complex validations involving multiple fields are further discussed below with respect to validation manager 416.

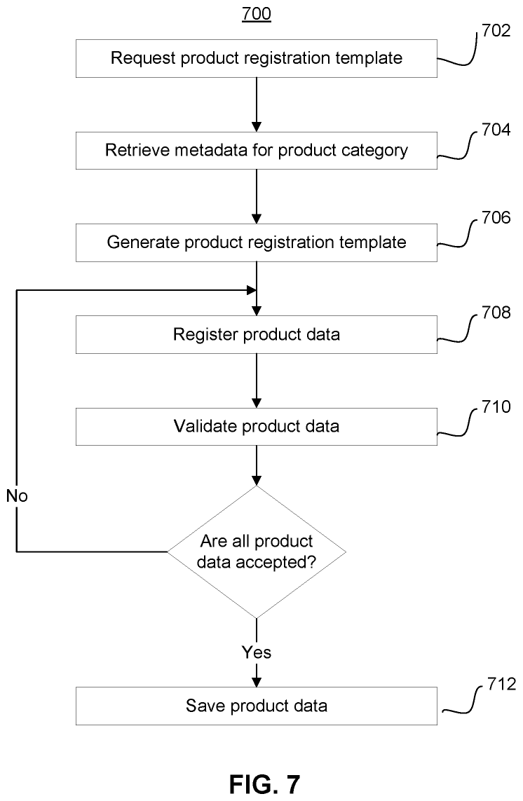

Processor 402 may execute validation manager 416, in some embodiments, after vendor 306 has input the product data, to check whether the product data are accepted by the respective JSON Schema saved in metadata database 314, where the respective JSON Schema is the JSON Schema which shares the same product category as the product data. Validation is further discussed below with respect to block 710 in FIG. 7. In other embodiments, validation manager 416 may support more complex validations that involve multiple fields. That is, there may be multiple JSON Schemas for a product category, each depending on a different value in an additional field. For example, the JSON Schemas for a clothing product category may depend on the vendor country. In this example, the validation rule for the field “Size” would be different for different countries, such as the United States and Germany. Similarly, different validation rules could check for different address formats, date formats, and the like. In some embodiments, processor 402 may send the respective JSON Schema along with the product registration template to vendor 306 so that the product properties may be validated on vendor interface 308. In such embodiment, vendor 306 may download the product registration template and the JSON Schema to input the product properties and validate them offline.

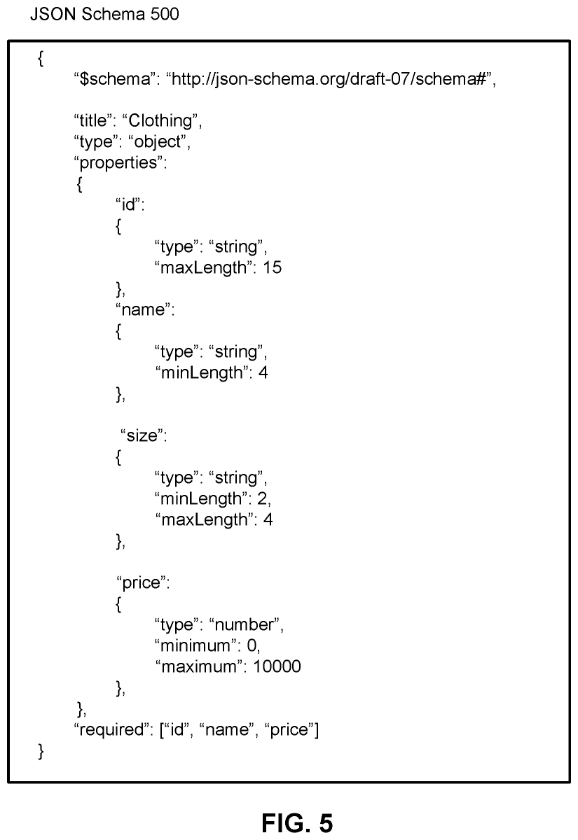

FIG. 5 is an example of a JSON Schema 500 with metadata for a clothing product category. FIG. 5 is shown as a JSON Schema by way of example, but the schema may be a schema in any language as long as it supports validation, such as XML Schema and the like. As shown in FIG. 5, JSON Schema 500 includes a plurality of fields, keys, and values for a product category, the plurality of fields, keys, and values comprising the metadata of the product category. For example, FIG. 5 shows that for the clothing product category, there are 4 property fields: id, name, size, and price. In this example, each property field has a number of keys defining the validation rules (type, maxLength, minLength, minimum, maximum, and required), but user 302 may add more or modify the existing keys as appropriate through user interface 304. In this case, the “type” value for “price” is “number”. That is, if vendor 306 inputs something other than a number in this field on their product registration template, when the system attempts to validate the product data, it will return an error. On the other hand, the “type” value for “id”, “name”, and “size”, is “string”, so vendor 306 must input a string of characters (not a number) for the product data to be accepted. Other keys such as “minLength”, “maxLength”, “minimum”, and “maximum” regulate the accepted length of the fields. Other keys may be used to ensure fields are formatted adequately, such as date, time, pattern, etc. Finally, if vendor 306 does not input anything for the fields “id”, “name”, or “price”, the system will also return an error since they are “required”, however, the field “size” may be left blank. JSON Schema 500 allows for the structure of data to be accurately described in a way that can be easily used for automating validation.

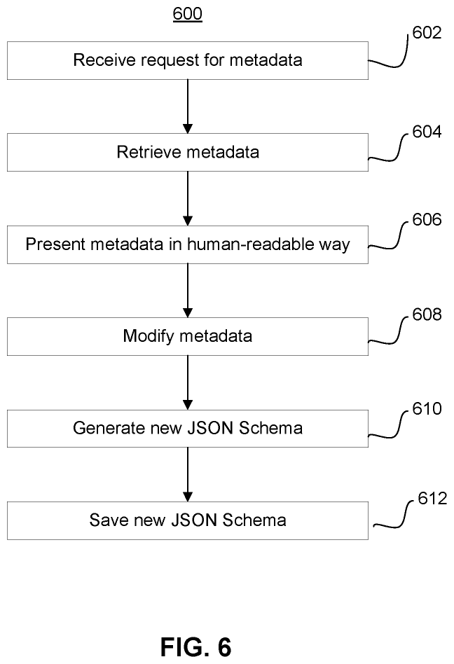

FIG. 6 is a flow chart illustrating an exemplary method 600 for managing metadata. Method 600 may be executed or otherwise performed by one or more combinations of various systems. Method 600 as described below may be carried out by elements of system 300, as explained below. Each block shown in FIG. 6 represents one or more processes, methods, or subroutines in the exemplary method 600. Referring to FIG. 6, exemplary method 600 begins at block 602.

At block 602, metadata manager 410 receives a request for metadata related to a product category. In some embodiments, metadata manager 410 may receive this request through network 310 from user 302, who interacts with user interface 304 to request the metadata. In some embodiments, this request may be made by means of an input device such as a mouse, keyboard, stylus pen, or the like. For example, user 302 may request to manage the metadata of product category “clothing.”

Once processor 402 receives the request for the metadata of the product category, method 600 proceeds to block 604. At block 604, processor 402 may execute metadata manager 410 to determine which metadata stored in metadata database 314 relates to the product category and then retrieve the determined metadata from metadata database 314. For example, processor 402 may receive a request to manage the metadata for product category “clothing.” Processor 402 then executes metadata manager 410 to find the metadata in metadata database 314 which relates to “clothing” (e.g., JSON Schema 500) and retrieve it from metadata database 314.

Once the metadata of the product category has been retrieved, method 600 proceeds to block 606. At block 606, metadata manager 410 may send the metadata of the product category in a clear, human-readable form (i.e., not JSON Schema) to user interface 304 through network 310, facilitating user 302 reading and making modifications to it. For example, user 302 may be able to manage the metadata through user interface 304 or by downloading, modifying, and uploading the modified metadata to user interface 304.

At block 608, user 302 may make changes to the metadata of the product category through user interface 304. For example, user 302 may delete the field “size” and add a new field “color” with the same keys as “size”, but different values. Once these changes have been made, method 600 proceeds to block 610. At block 610, the modified metadata is sent to processor 402 through network 310. Processor 402 may then execute JSON Schema generator 414 to write a new JSON Schema for the product category based on the modified metadata received from user interface 304.

Method 600 then proceeds to block 612, at which processor 402 may execute metadata manager 410 to save the new JSON Schema in metadata database 314, overwriting the previous version of the JSON Schema for the product category.

FIG. 7 is a flowchart illustrating an exemplary method 700 of product registration. Method 700 may be executed or otherwise performed by one or more combinations of various systems. Method 700 as described below may be carried out by elements of system 300, as explained below. Each block shown in FIG. 7 represents one or more processes, methods, or subroutines in the exemplary method 700. Referring to FIG. 7, exemplary method 700 begins at block 702.

At block 702, processor 402 receives a request for a product registration template for a product category. In some embodiments, processor 402 may receive this request through network 310 from vendor 306, who interacts with vendor interface 308 to request the product registration template by inputting the product category. In some embodiments, this request may be made by means of an input device such as a mouse, keyboard, stylus pen, or the like. For example, vendor 306 may request a product registration template for product category “clothing.”

Once the request for the product registration template is received by processor 402, method 700 proceeds to block 704. At block 704, processor 402 may execute metadata manager 410 to determine which metadata stored in metadata database 314 relates to the product category and retrieve the determined metadata from metadata database 314. For example, processor 402 may receive a request for a product registration template for product category “clothing.” Processor 402 may then execute metadata manager 410 to find the metadata in metadata database 314 which relates to “clothing” (e.g., JSON Schema 500) and retrieve it from metadata database 314.

Once the metadata of the product category has been retrieved from metadata database 314, method 700 proceeds to block 706. At block 706, processor 402 may execute template generator 412 to generate a product registration template for the product category based on its metadata and send the product registration template to vendor interface 308. The product registration template may be presented in different formats, e.g., application programming interface (API) or spreadsheet format.

At block 708, vendor 306 may input product data for one or more products using the product registration template. For example, vendor 306 may input the product data through vendor interface 308 or by downloading the product registration template, inputting the product data, and uploading the product registration template with the product data to vendor interface 308. Once the product data have been input, method 700 proceeds to block 710. At block 710, the product data are sent to processor 402 through network 310. Processor 402 may then execute validation manager 416 to compare the JSON Schema of the product category to the product data to check for matches, consistent with the requirements for JSON Schema validation, as discussed above with respect to FIG. 5. In some embodiments, if not all product data are accepted, method 700 returns to block 708 where vendor 306 will receive an error message and be prompted to reinput the product data. If all product data are accepted, method 700 proceeds to block 712. At block 712, product registration server 312 may save the product data onto one or more of the devices represented in system 100.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blue-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for registering one or more products on a web server, the system comprising:
a memory storing instructions; and
one or more processors configured to execute the instructions to perform steps comprising:
receiving a request from a user device for a product registration template for a product category;
retrieving metadata relating to the product category from a first database; 2vgenerating a product registration template by extracting fields from the metadata, wherein the product registration template includes a form configured to enable the user device to provide product properties corresponding to the extracted fields for one or more products;
sending the product registration template to the user device;
receiving the product properties corresponding to the extracted fields for the one or more products through the user device providing data into the form of the product registration template;
validating the received product properties against a predefined schema;
storing the validated product properties in a second database; and
registering the one or more products on the web server.

2. The system of claim 1, wherein validating the product properties comprises:
determining whether the product properties match a predetermined structure set by the predefined schema for the product category.

3. The system of claim 2, wherein the predefined schema comprises one or more fields, each of the one or more fields defining a value, and one or more validation rules being associated with each of the one or more fields.

4. The system of claim 3, wherein the value comprises a character string, an integer, a real number, an object, an array, an enum, a constant, a pattern, content media, boolean, or null.

5. The system of claim 3, wherein the request for the product registration template includes user data related to a user operating the user device and wherein validating the product properties further comprises:
changing the validation rules based on the user data.

6. The system of claim 1, wherein sending the product registration template to the user device further comprises:
sending the predefined schema to the user device.

7. The system of claim 1, wherein the predefined schema is a JavaScript Object Notation (JSON) Schema.

8. The system of claim 1, wherein the product registration template comprises one of a webpage form, a spreadsheet, or an application programming interface (API).

9. The system of claim 1, wherein the one or more processors are further configured to execute the instructions to perform steps comprising:
receiving the metadata for the product category through the user device;
generating the predefined schema based on the metadata; and
storing the predefined schema in the first database.

10. A computer-implemented method for registering one or more products on a web server, the method comprising:
receiving a request from a user device for a product registration template for a product category;
retrieving metadata relating to the product category from a first database;
generating a product registration template by extracting fields from the metadata, wherein the product registration template includes a form configured to enable the user device to provide product properties corresponding to the extracted fields for one or more products;
sending the product registration template to the user device;
receiving the product properties corresponding to the extracted fields for the one or more products through the user device providing data into the form of the product registration template;
validating the received product properties against a predefined schema;
storing the validated product properties in a second database; and
registering the one or more products on the web server.

11. The method of claim 10, wherein validating the product properties comprises:
determining whether the product properties match a predetermined structure set by the predefined schema for the product category.

12. The method of claim 11, wherein the predefined schema comprises one or more fields, each of the one or more fields defining a value, and one or more validation rules being associated with each of the one or more fields.

13. The method of claim 12, wherein the value comprises a character string, an integer, a real number, an object, an array, an enum, a constant, a pattern, content media, boolean, or null.

14. The method of claim 12, wherein the request for the product registration template includes user data related to a user operating the user device and wherein validating the product properties further comprises:
changing the validation rules based on the user data.

15. The method of claim 10, wherein sending the product registration template to the user device further comprises:
sending the predefined schema to the user device.

16. The method of claim 10, wherein the predefined schema is a JavaScript Object Notation (JSON) Schema.

17. The method of claim 10, wherein the product registration template comprises one of a webpage form, a spreadsheet, or an application programming interface (API).

18. The method of claim 10, wherein the method further comprises:
receiving the metadata for the product category through the user device;
generating the predefined schema based on the metadata; and
storing the predefined schema in the first database.

19. A computer-implemented system for registering one or more products on a web server, the system comprising:
a memory storing instructions; and
one or more processors configured to execute the instructions to perform steps comprising:
receiving metadata for a product category through a user device;
generating a schema based on the received metadata;
storing the schema in a first database;
receiving a request from the user device for a product registration template for the product category;
retrieving the schema relating to the product category from the first database;
generating a product registration template by extracting fields from the schema, wherein the product registration template includes a form configured to enable the user device to provide product properties corresponding to the extracted fields for one or more products;
sending the product registration template to the user device;
receiving the product properties corresponding to the extracted fields for the one or more products through the user device providing data into the form of utilizing the product registration template;
validating the received product properties by determining whether the product properties match a structure set by the schema;
storing the validated product properties in a second database; and
registering the one or more products on the web server.

20. The system of claim 19, wherein the schema comprises one or more fields, each of the one or more fields defining a value, and one or more validation rules being associated with each of the one or more fields.
